(19) United States
(12) Patent Application Publication
(10) Pub. No.: US 2019/0354833 A1
(43) Pub. Date: Nov. 21, 2019

(54) METHOD AND SYSTEM FOR REDUCING COMMUNICATION FREQUENCY IN NEURAL NETWORK SYSTEMS

(71) Applicant: Advanced Micro Devices, Inc., Santa Clara, CA (US)

(72) Inventor: Abhinav Vishnu, Austin, TX (US)

(73) Assignee: Advanced Micro Devices, Inc., Santa Clara, CA (US)

(21) Appl. No.: 16/027,454

(22) Filed: Jul. 5, 2018

Related U.S. Application Data
(60) Provisional application No. 62/673,450, filed on May 18, 2018.

(51) Int. Cl. G06N 3/04; G06N 3/08; G06N 3/063

(52) U.S. Cl. CPC G06N 3/04; G06N 3/063; G06N 3/08

(57) ABSTRACT

Methods and systems for reducing communication frequency in neural networks (NN) are described. The method includes running, in an initial epoch, mini-batches of samples from a training set through the NN and determining one or more errors from a ground truth, where the ground truth is the given label for the sample. The errors are recorded for each sample and are sorted in a non-decreasing order. In a next epoch, mini-batches of samples are formed starting from the sample which has the smallest error in the sorted list. The parameters of the NN are updated and the mini-batches are run. A mini-batch(es) are communicated to the other processing elements if a previous update has resulted in making a significant impact on the NN, where significant impact is measured by determining if the errors or accumulated errors since the last communication update meet or exceed a significance threshold.

### CROSS REFERENCE TO RELATED APPLICATION

This application claims the benefit of U.S. provisional application No. 62/673,450 having a filing date of May 18, 2018, which is incorporated by reference as if fully set forth herein.

### BACKGROUND

Deep neural networks (DNNs) are used for many artificial intelligence and machine learning applications. These DNNs nominally include multiple hidden layers between an input layer and an output layer. Recently, DNNs have started to use an increasing number of layers which provide increased capacity and accuracy for various prediction problems in image, video, and speech recognition processing and analysis. However, deeper DNNs also result in increasingly greater performance challenges. For example, DNNs are extremely computationally expensive. It is not uncommon for a training task for a neural network to require days, weeks or even months to be performed.

To reduce the training time, multiple device architectures are used that enable the efficient distributed training of neural networks. However, these multiple device architectures require frequent communication between each of the processing elements to update the parameters of each neural network on each processing element with the updates from the other processing elements as each of the neural networks learn and converge to a solution. Consequently, there is significant traffic on the communication buses that connect the processing elements.

The speed at which updates can be sent between the processing elements is effectively the bottleneck to distributively training neural networks as the processing elements are becoming increasingly faster than the communication buses. The increased levels of communications traffic widens the imbalance between communication and computation and increases the overall time for neural network training.

### BRIEF DESCRIPTION OF THE DRAWINGS

A more detailed understanding may be had from the following description, given by way of example in conjunction with the accompanying drawings wherein:

FIG. 1 is a block diagram of an example device in accordance with certain implementations;

FIG. 2 is a block diagram of the device of FIG. 1 in accordance with certain implementations;

FIG. 3 is a block diagram of an Heterogeneous System Architecture (HSA) platform in accordance with certain implementations;

FIG. 4 is a block diagram of an example system illustrating queue structures in accordance with certain implementations;

FIG. 5A is an example block diagram of command packet processing in accordance with certain implementations;

FIG. 5B shows an example element that includes command packets and an indirect buffer (IB) command packet in accordance with certain implementations;

FIG. 5C is an example indirect buffer in accordance with certain implementations;

FIG. 6 illustrates an example neural network hardware architecture in accordance with certain implementations;

FIG. 7 illustrates two representative layers of a deep neural network (DNN) in accordance with certain implementations;

FIG. 8 illustrates a neuron in accordance with certain implementations; and

FIG. 9 is a flowchart for a method for reducing the frequency of communications in neural networks in accordance with certain implementations.

### DETAILED DESCRIPTION

Described herein is a method and system for reducing frequency of communication in neural network systems. The method includes computing the errors for samples run in a neural network, and sorting the samples after each epoch in a non-decreasing order of error, where the error is the difference between a ground truth and a prediction. In an illustrative definition, an epoch is the interval for completing a run through the neural network and the ground truth for a sample is the actual or given label for the sample/image. The updates (based on the errors) are then coalesced from multiple mini-batches of samples to reduce the ratio of communication to computation. Since the majority of samples have low errors, and increasingly so as the neural network converges to a solution, the method reduces the overall level of communications on the communications bus. The method addresses the imbalance between communication and computation, where processing elements, such as graphics processing units (GPUs), are becoming increasingly faster than the communication buses, such as Peripheral Component Interconnect Express (PCI-Ex). Communication buses such as the PCI-Ex can be more efficiently used without having to use higher bandwidth-based interconnects.

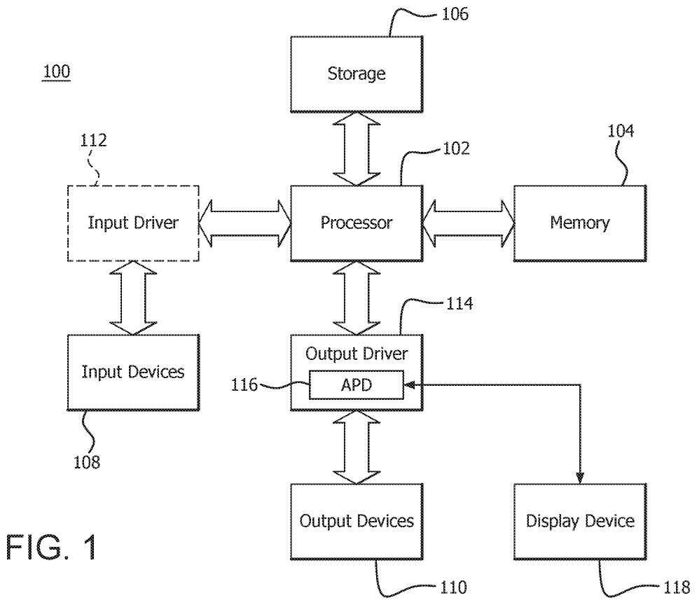

FIG. 1 is a block diagram of an example device 100 in which one or more features of the disclosure can be implemented. The device 100 includes, for example, a computer, a gaming device, a handheld device, a set-top box, a television, a mobile phone, or a tablet computer. The device 100 includes a processor 102, a memory 104, a storage 106, one or more input devices 108, and one or more output devices 110. The device 100 also optionally includes an input driver 112 and an output driver 114. It is understood that the device 100 includes additional components not shown in FIG. 1.

In various alternatives, the processor 102 includes a central processing unit (CPU), a graphics processing unit (GPU), a CPU and GPU located on the same die, or one or more processor cores, wherein each processor core can be a CPU or a GPU. In various alternatives, the memory 104 is located on the same die as the processor 102, or is located separately from the processor 102. The memory 104 includes a volatile or non-volatile memory, for example, random access memory (RAM), dynamic RAM, or a cache.

The storage 106 includes a fixed or removable storage, for example, a hard disk drive, a solid state drive, an optical disk, or a flash drive. The input devices 108 include, without limitation, a keyboard, a keypad, a touch screen, a touch pad, a detector, a microphone, an accelerometer, a gyroscope, a biometric scanner, or a network connection (e.g., a wireless local area network card for transmission and/or reception of wireless IEEE 802 signals). The output devices 110 include, without limitation, a display, a speaker, a printer, a haptic feedback device, one or more lights, an antenna, or a network connection (e.g., a wireless local area network card for transmission and/or reception of wireless IEEE 802 signals).

The input driver 112 communicates with the processor 102 and the input devices 108, and permits the processor 102 to receive input from the input devices 108. The output driver 114 communicates with the processor 102 and the output devices 110, and permits the processor 102 to send output to the output devices 110. It is noted that the input driver 112 and the output driver 114 are optional components, and that the device 100 will operate in the same manner if the input driver 112 and the output driver 114 are not present. The output driver 114 includes an accelerated processing device (“APD”) 116 which is coupled to a display device 118. The APD accepts compute commands and graphics rendering commands from processor 102, to processes those compute and graphics rendering commands, and provides pixel output to display device 118 for display.

As described in further detail below, the APD 116 includes one or more parallel processing units configured to perform computations in accordance with a single-instruction-multiple-data (“SIMD”) paradigm. Thus, although various functionality is described herein as being performed by or in conjunction with the APD 116, in various alternatives, the functionality described as being performed by the APD 116 is additionally or alternatively performed by other computing devices having similar capabilities that are not driven by a host processor (e.g., processor 102) and configured to provide (graphical) output to a display device 118. For example, it is contemplated that any processing system that performs processing tasks in accordance with a SIMD paradigm can perform the functionality described herein. Alternatively, it is contemplated that computing systems that do not perform processing tasks in accordance with a SIMD paradigm performs the functionality described herein.

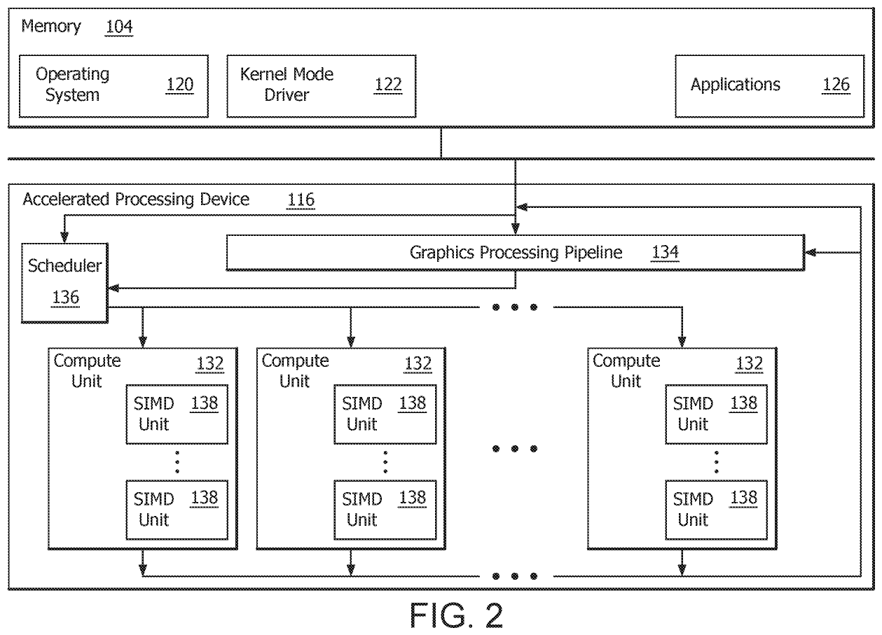

FIG. 2 is a block diagram of the device 100, illustrating additional details related to execution of processing tasks on the APD 116. The processor 102 maintains, in system memory 104, one or more control logic modules for execution by the processor 102. The control logic modules include an operating system 120, a kernel mode driver 122, and applications 126. These control logic modules control various features of the operation of the processor 102 and the APD 116. For example, the operating system 120 directly communicates with hardware and provides an interface to the hardware for other software executing on the processor 102. The kernel mode driver 122 controls operation of the APD 116 by, for example, providing an application programming interface (“API”) to software (e.g., applications 126) executing on the processor 102 to access various functionality of the APD 116. The kernel mode driver 122 also includes a just-in-time compiler that compiles programs for execution by processing components (such as the SIMD units 138 discussed in further details below) of the APD 116.

The APD 116 executes commands and programs for selected functions, such as graphics operations and non-graphics operations that are suited for parallel processing and/or non-ordered processing. The APD 116 is used for executing graphics pipeline operations such as pixel operations, geometric computations, and rendering an image to display device 118 based on commands received from the processor 102. The APD 116 also executes compute processing operations that are not directly related to graphics operations, such as operations related to video, physics simulations, computational fluid dynamics, or other tasks, based on commands received from the processor 102.

The APD 116 includes compute units 132 that include one or more SIMD units 138 that perform operations at the request of the processor 102 in a parallel manner according to a SIMD paradigm. The SIMD paradigm is one in which multiple processing elements share a single program control flow unit and program counter and thus execute the same program but are able to execute that program with different data. In one example, each SIMD unit 138 includes sixteen lanes, where each lane executes the same instruction at the same time as the other lanes in the SIMD unit 138 but executes that instruction with different data. Lanes can be switched off with predication if not all lanes need to execute a given instruction. Predication can also be used to execute programs with divergent control flow. More specifically, for programs with conditional branches or other instructions where control flow is based on calculations performed by an individual lane, predication of lanes corresponding to control flow paths not currently being executed, and serial execution of different control flow paths allows for arbitrary control flow. In an implementation, each of the compute units 132 can have a local L1 cache. In an implementation, multiple compute units 132 share a L2 cache.

The basic unit of execution in compute units 132 is a work-item. Each work-item represents a single instantiation of a program that is to be executed in parallel in a particular lane. Work-items can be executed simultaneously as a “wavefront” on a single SIMD unit 138. One or more wavefronts are included in a “work group,” which includes a collection of work-items designated to execute the same program. A work group is executed by executing each of the wavefronts that make up the work group. In alternatives, the wavefronts are executed sequentially on a single SIMD unit 138 or partially or fully in parallel on different SIMD units 138. The wavefronts can be thought of as the largest collection of work-items that can be executed simultaneously on a single SIMD unit 138. Thus, if commands received from the processor 102 indicate that a particular program is to be parallelized to such a degree that the program cannot execute on a single SIMD unit 138 simultaneously, then that program is broken up into wavefronts which are parallelized on two or more SIMD units 138 or serialized on the same SIMD unit 138 (or both parallelized and serialized as needed). A scheduler 136 is configured to perform operations related to scheduling various wavefronts on different compute units 132 and SIMD units 138.

The parallelism afforded by the compute units 132 is suitable for graphics related operations such as pixel value calculations, vertex transformations, and other graphics operations. Thus in some instances, a graphics pipeline 134, which accepts graphics processing commands from the processor 102, provides computation tasks to the compute units 132 for execution in parallel.

The compute units 132 are also used to perform computation tasks not related to graphics or not performed as part of the “normal” operation of a graphics pipeline 134 (e.g., custom operations performed to supplement processing performed for operation of the graphics pipeline 134). An application 126 or other software executing on the processor 102 transmits programs that define such computation tasks to the APD 116 for execution.

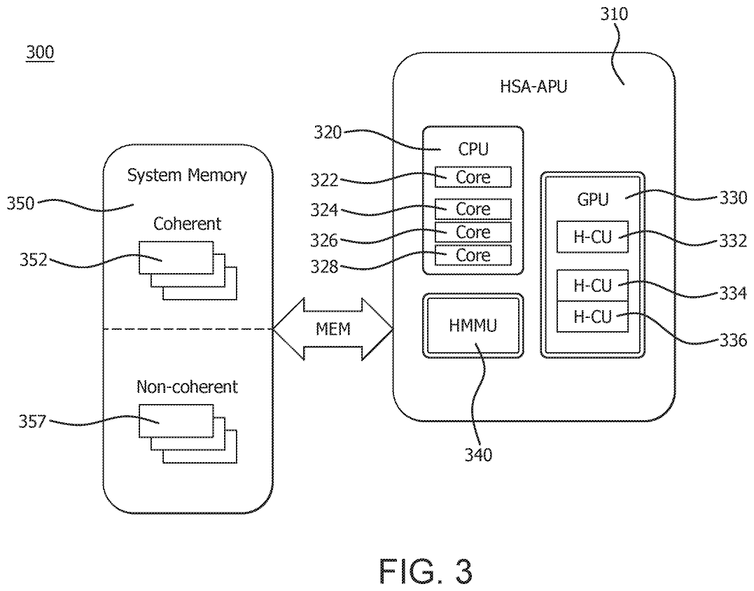

FIG. 3 illustrates a Heterogeneous System Architecture (HSA) platform 300 based in part on the devices of FIGS. 1 and 2. The HSA platform 300 includes a HSA Accelerated Processing Unit (APU) 310 connected to or in communication with (collectively “connected to”) a system memory 350. The HSA APU 310 contains a multi-core CPU 320, a GPU 330 with multiple HSA compute units (H-CUs) 332, 334, 336, and a HSA memory management unit (HMMU or HSA MMU) 340. The CPU 320 includes any number of cores, with cores 322, 324, 326, 328 shown in FIG. 3. The GPU 330 includes any number of H-CUs although three are shown in FIG. 3. While a HSA is specifically discussed and presented in the described implementations, the present system and method can be utilized on either a homogenous or heterogeneous system. The system memory 350 includes one or both of coherent system memory 352 and non-coherent system memory 357.

The HSA 300 provides a unified view of fundamental computing elements. The HSA 300 allows a programmer to write applications that seamlessly integrate CPUs 320, also referred to as latency compute units, with GPUs 330, also referred to as throughput compute units, while benefiting from the best attributes of each. The HSA 300 allows the programmer to take advantage of the parallel processor in the GPU 330 as a peer to the traditional multi-core CPU 320, where each core can run one or more threads. A peer device is defined as an HSA device that shares the same memory coherency domain as another device.

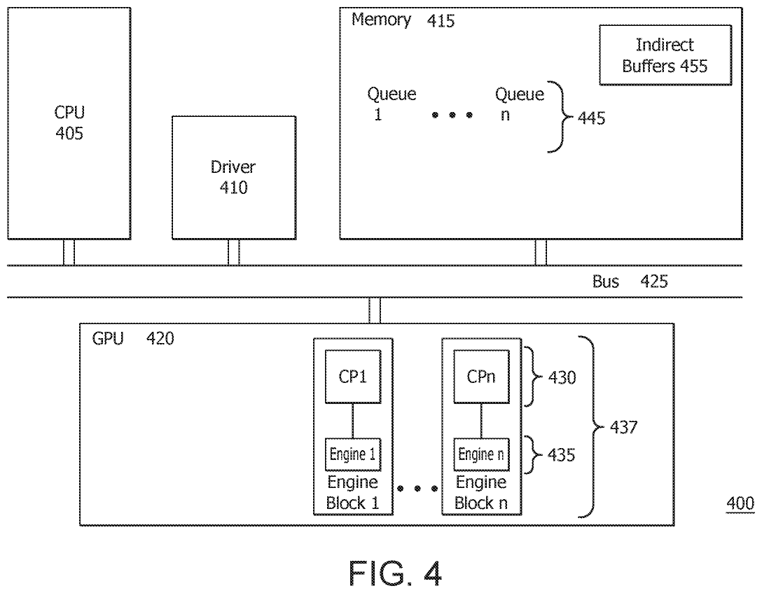

The devices in the HSA 300 communicate with one another using queues as further explained with reference to FIGS. 4-6. Queues are an integral part of the HSA architecture. A queue is a physical memory area where a producer places a request for a consumer. Depending on the complexity of the HSA hardware, queues might be managed by any combination of software or hardware. Hardware managed queues have a significant performance advantage in the sense that an application running on latency processors (such as CPU 320) queues work to throughput processors (such as GPU 330) directly, without the need for any intervening operating system calls. This allows for very low latency communication between the devices in the HSA 300.

FIG. 4 is a block diagram of an example system 400 illustrating queue structures. The system 400 includes a CPU 405, a system memory 415, a driver 410, a graphics processing unit (GPU) 420, and a communication infrastructure or bus 425. A person of skill in the art will appreciate that system 400 includes software, hardware, and firmware components in addition to, or different from, that shown in FIG. 4. It is understood that the system 400 includes additional components not shown in FIG. 4.

The CPU 405, GPU 420 and system memory 415 can be implemented as described with respect to FIGS. 1-3. The CPU 405 executes an operating system (not shown) and one or more applications, and is the control processor for system 400. The operating system executing on CPU 405 controls, facilitates access and coordinates the accomplishment of tasks with respect to system 400. The driver 410 (e.g., a graphics driver) includes software, firmware, hardware, or any combination thereof. In an implementation, the driver 410 is implemented entirely in software. The driver 410 provides an interface and/or application programming interface (API) for the CPU 405 and applications executing on the CPU 405 to access the GPU 420. The bus 425 provides coupling between the components of system 400 and includes one or more communication buses such as Peripheral Component Interconnect (PCI), Advanced Graphics Port (AGP), and the like.

The GPU 420 provides graphics acceleration functionality and other compute functionality as described herein to system 400. The GPU 420 includes multiple command processors (CP) CP 1 . . . CP n 430, and multiple engines Engine 1 . . . Engine n 435, for example, 3D engines, unified video decoder (UVD) engines, digital rights management (DRM) direct memory access (DMA) engines and the like.

The CP 1 . . . CP n 430 controls the processing within GPU 420 and is connected to Engine 1 . . . Engine n 435. Each CP 1 . . . CP n 430 is associated with Engine 1 . . . Engine n 435 and each pair is an engine block (EB) EB 1 . . . EB n 437. In another embodiment, the CP 1 . . . CP n 430 is a single command processor. In general, the CP 1. . . CP n 430 receives instructions to be executed from the CPU 405, and coordinates the execution of those instructions on Engine 1 . . . Engine n 435 in GPU 420. In some instances, the CP 1 . . . CP n 430 generates one or more commands to be executed in GPU 420, that correspond to each command received from CPU 405. Logic instructions implementing the functionality of the CP 1 . . . CP n 430 is implemented in hardware, firmware, or software, or a combination thereof.

The memory 415 includes one or more memory devices and can be a dynamic random access memory (DRAM) or a similar memory device used for non-persistent storage of data. Memory 415 includes one or more memory buffers 445 through which CPU 405 communicates commands to GPU 420. The memory buffers 445 correspond to the engines 435 or the engine blocks 437, as appropriate. Memory buffers 445 are implemented as queues, ring buffers or other data structures suitable for efficient queuing of work items or command packets. In the instance of a queue, command packets are placed into and taken away from the memory buffers 445 in a circular manner. For purposes of illustration, memory buffers 445 are referred to as queue 1 . . . queue n 445 herein.

The memory 415 includes indirect buffers 455. The indirect buffers 455 hold the actual commands (e.g., instructions, data, pointers and non-pointers). For example, when the CPU 405 communicates a command packet to the GPU 420, the command packet is stored in the indirect buffer 455 and a pointer to that indirect buffer 455 is inserted in a queue 1 . . . queue n 445. As described herein below, certain of the indirect buffers 455 hold neuron data. That is, multiple indirect buffers are used for different purposes. The CPU 405, via driver 410, as a writer of the commands to queue 1 . . . queue n 445 and the GPU 420 as a reader of such commands, coordinate a write pointer and read pointer indicating the last item added and last item read, respectively, in queue 1 . . . queue n 445.

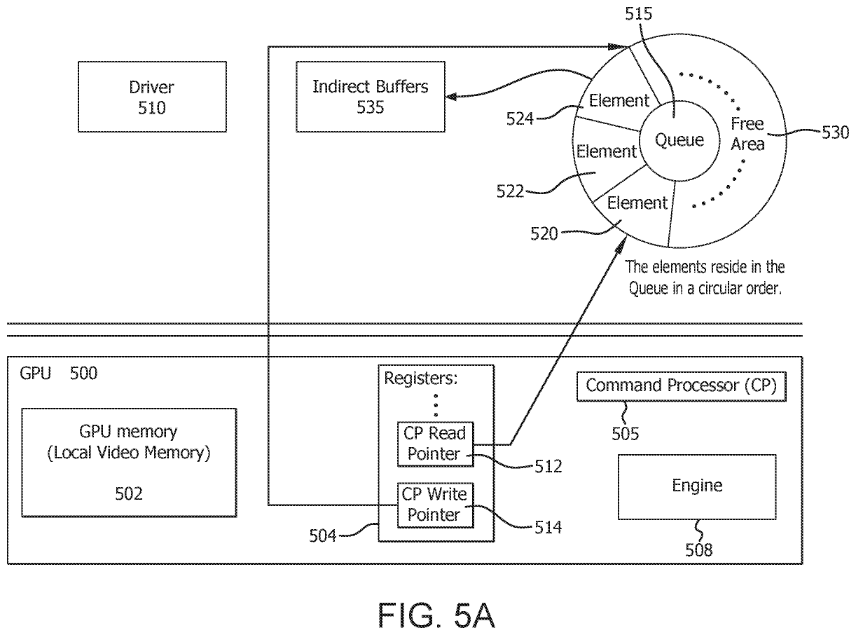

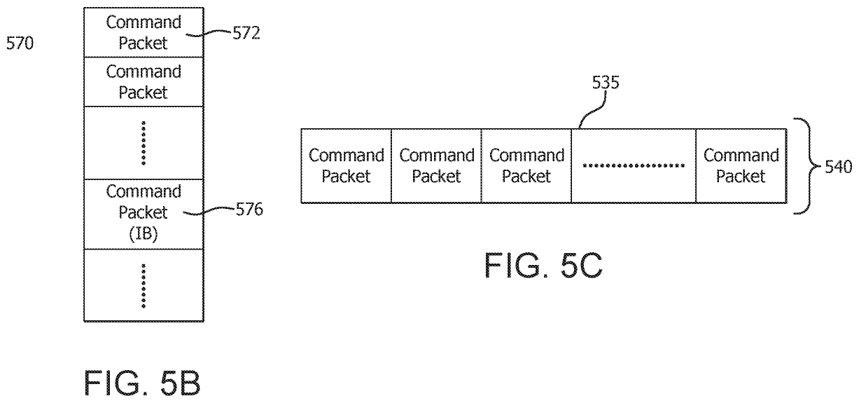

FIG. 5A is an example block diagram of command packet processing as between a GPU 500, a driver 510, a queue 515 and indirect buffer 535. The GPU 500 includes a GPU memory 502, registers 504, a command processor 505, and an engine 508. The registers 504 include a read pointer 512 and a write pointer 514. The queue 515 includes elements 520, 522, 524 and free space 530. Each element, for example, elements 520, 522, 524 store queue packets. FIG. 5B shows an example element 570 that includes command packets 572 and an indirect buffer (IB) command packet 576 which points to the indirect buffer 535. The indirect buffer 535, as shown in FIG. 5C, includes command packets 540 which instruct the GPU 500 to carry out operations. For example, a kernel dispatch packet (an example of the command packet 540) in HSA includes information such as how a computation kernel should launch threads (grid dimension, workgroup size), required size of private and group memory allocations, handle for an object in memory that includes an executable ISA image for the computation kernel, and additional control and synchronization information. In general, the computation kernels, in DNN, are usually convolution, matrix multiply, fast Fourier transform (FFT), pooling, and activations which are implemented by high-level libraries such as for example MIOpen and rocBLAS.

The above architecture provides a one-way communication from a host processor (the writer as represented by the driver 510) to the GPU 500 (the reader as represented by the command processor 505). Initially the read pointer 512 and the write pointer 514 point to the same location indicating that the queue 515 is empty. The queue 515 has free space 530 into which the driver 510 writes a command packet corresponding to a task. The driver 510 then updates the write pointer 514 to one position past the last command packet or the first available space. The write pointer 514 and read pointer 512 are now pointing to different locations. The command processor 505 fetches command packets at the read pointer 512 position and walks the read pointer 512 until it is equal to the write pointer 514.

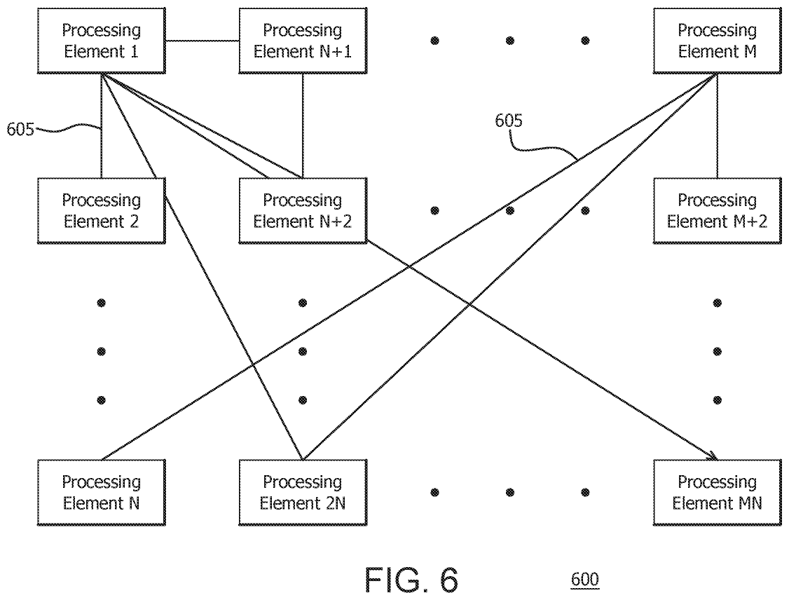

FIG. 6 shows illustrative neural network hardware architecture 600 based in part on the devices of FIGS. 1-5C in accordance with certain implementations. Neural network hardware architecture 600 includes processing elements 1 . . . MN connected by a communications network, bus or interface 605 (collectively “communications bus”), where each processing element 1 . . . MN includes a copy of a neural network or a portion thereof in accordance with a given configuration. For example, the neural network hardware architecture 600 is implementable for model parallelism, data parallelism, a parameter-server based approach or message passing interface execution models. In an implementation, the neural network is a DNN. In an implementation, each processing element 1 . . . MN includes multiple processing elements.

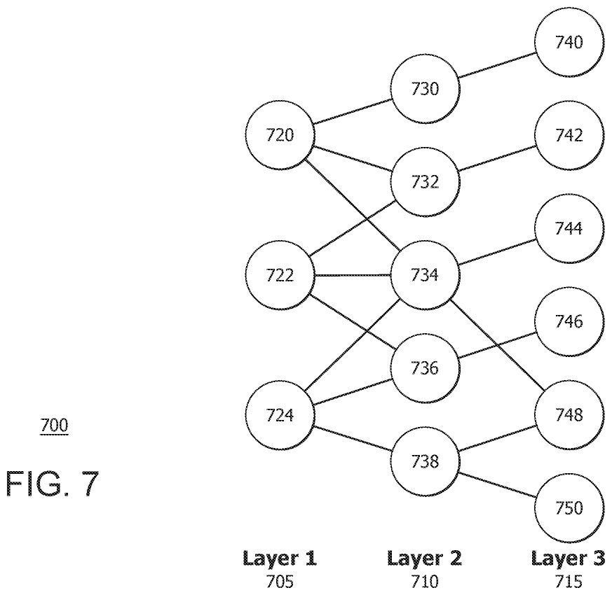

FIG. 7 illustrates a DNN 700 with three representative layers, layer 1 705, layer 2 710 and layer 3 715. Layer 1 705 includes, for example, neurons 720, 722, and 724, layer 2 710 includes, for example, neurons 730, 732, 734, 736 and 738, and layer 3 715 includes, for example, neurons 740, 742, 744, 746, 748 and 750. The neurons can be connected to the other neurons in a number of variations including fully connected or sparsely connected implementations.

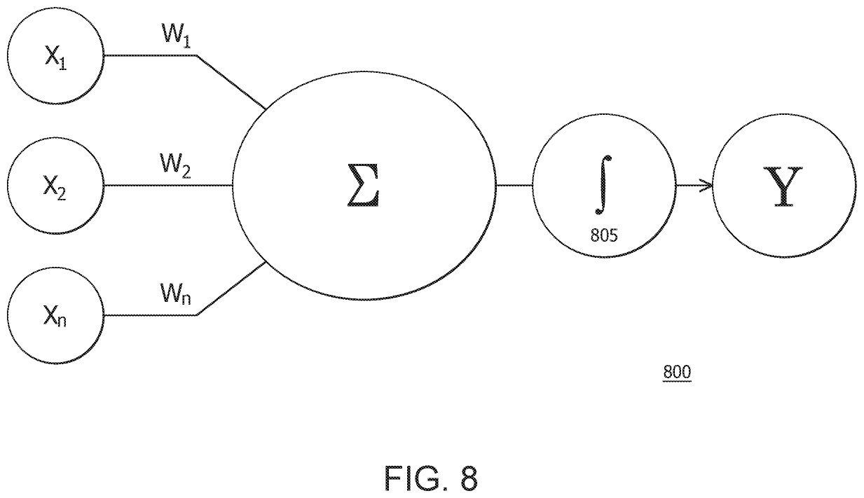

FIG. 8 illustrates a neuron 800, which accepts inputs X₁, X₂, . . . , Xₙ. The inputs are multiplied by an associated set of weights W₁, W₂, . . . , Wₙ, each of which assigns a significance to the input as the DNN learns. The weighted inputs are summed and applied to an activation function 805, which determines the extent to which the signal progresses through the DNN. For example, the activation function 805 determines an output Y.

Neural networks learn or train by comparing their classification of a sample with a ground truth classification of the sample. An error is defined as difference between what the neural network perceives and a ground truth. As each sample is run through the neural network, errors are determined and used to modify the weights, e.g., W₁, W₂, . . . , Wₙ, in the neural network. This is done iteratively for a given number of times. In general, updates based on the errors are communicated between each of the processing elements, e.g., processing elements 1 . . . MN, via a communications bus, e.g., the communications bus 425 or 605.

Frequent communication between each of the processing elements is necessary to update the weights of each neural network on each processing element with the updates from the other processing elements as each of the neural networks learn and converge to a solution. Consequently, there is significant traffic on the communication buses that connect the processing elements.

A commonly used method for adjusting the weights according to the error is gradient descent, which attempts to determine adjusted weights which results in lesser errors, where the reference to error means or relates to the order of the magnitude of the errors. One form of gradient descent implementation updates the neural network after each error determination and is computationally and communications extensive. Another form of gradient descent, batch gradient descent, updates the neural network after all samples in a training set are completed. Yet another form of gradient descent, mini-batch gradient descent, divides the training set into small batches (hereinafter mini-batches) and updates the neural network after the mini-batch is completed. Under multi-device or multi-node settings, the weights need to be synchronized. In the specific case of data parallelism, the synchronization is done in an all-to-all reduction. By default this is done after every batch or mini-batch. However, this limits parallelism by putting pressure on the communication bus.

A method and system addresses the bandwidth limitations of existing communications buses and cluster interconnects by reducing the communication frequency between processing elements. The method minimizes how fast the communication bus needs to be by minimizing the number of communication updates that need to be done. The communications pressure is alleviated by decreasing the communication frequency using the following heuristic: compute the error of each sample in a mini-batch and record it; sort the sample indices in non-decreasing order of errors; and coalesce the updates from several mini-batches to reduce the communication frequency. In an implementation, coalescing is done without sorting the errors first. For very large datasets, the coalescing reduces the communication frequency and improves the quality of the gradients without affecting accuracy. In an implementation, the method is realized by masking the communication updates and only conducting the communication updates when a locally accumulated error meets a significance threshold.

The method leverages the properties of deep learning or neural network algorithms and the datasets which are used for training the neural networks. The training datasets usually include a large distribution of samples, the majority of which are easily classified correctly, in addition to a few borderline samples, and another set of noisy samples. The distributed memory implementations usually implement mini-batch gradient descent, where the processing elements (also known as compute nodes) synchronize their neural networks after learning from each mini-batch. The described method reduces the communication frequency by computing the error for each sample at the end of each mini-batch and recording the computed error. The sample indices are then sorted in non-decreasing order of the error. In an implementation, the communication updates for low error samples are then coalesced since their updates are proportionally smaller in comparison to the high error samples. The coalescing fundamentally reduces the frequency of global synchronization for the mini-batch updates since the updates from a large number of small error samples is combined together. This reduces the overall pressure on the communication buses including system on chip buses or cluster interconnects.

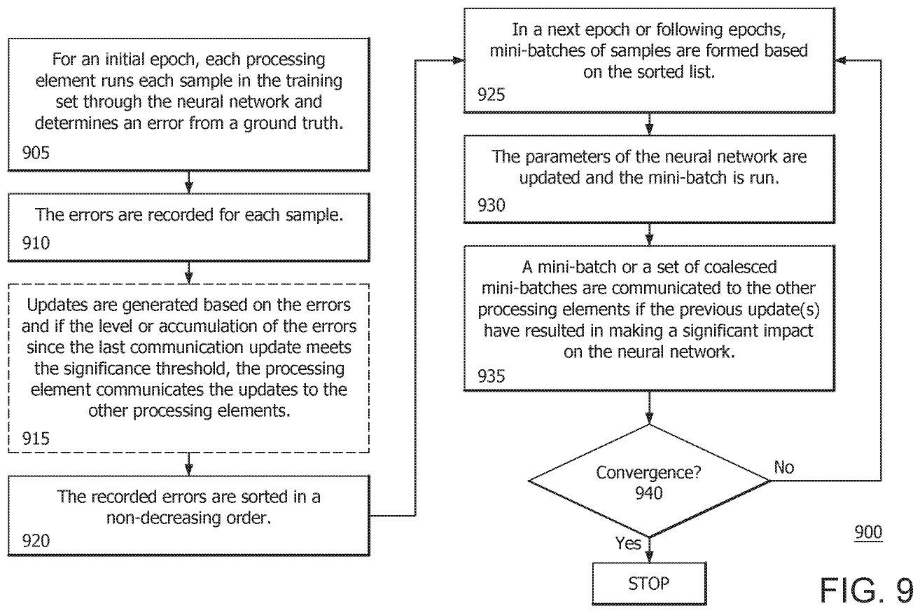

FIG. 9 is a flowchart for a method 900 for reducing communications in a neural network system which includes multiple processing elements interconnected via a communications bus, where each processing element has a neural network instance or copy and a training set of samples. The samples, for example, can be images or any other like classifiable element. For an initial epoch, each processing element runs each sample in the training set through the neural network and determines an error from a ground truth (step 905). In an implementation, the training set is divided into mini-batches and the mini-batches are run through the neural network. The mini-batch size, for example, is 16 or 32 samples. The errors are recorded for each sample (step 910). In an implementation, updates are generated based on the errors and if the level or accumulation of the errors since the last communication update meets the significance threshold, the processing element communicates the updates to the other processing elements (optional step 915). The recorded errors are sorted in a non-decreasing order (step 920), where non-decreasing means that consecutive errors are the same or are increasing. Alternatively stated, the errors are sorted from smallest (or lowest) error to largest (or highest) error. The sorted list impacts which samples get run first and which updates get communicated to the other processing elements.

In a next epoch or following epochs, mini-batches of samples are formed based on the sorted list (step 925). In an implementation, the mini-batches are formed starting from the sample which has the smallest error in the sorted list. In another implementation, the mini-batches alternate between samples with low errors and samples with high errors. That is, one mini-batch is formed starting from a sample which has the smallest error and a next mini-batch is formed starting from a sample which has the largest error. The parameters of the neural network are updated and the mini-batch is run (step 930). The updates related to a mini-batch or a set of coalesced mini-batches are communicated to the other processing elements if the updates have resulted in making a significant impact on the neural network (step 935). In this instance, significant impact is measured, for example, by determining if the errors or accumulated errors since the last communication update meet or exceed the significance threshold. The significance threshold is set, for example, based on desired features or characteristics such as, for example, by using an average of the maximum and minimum error as the significance threshold. The process starts over for further epochs until convergence is achieved (step 940).

In an implementation, the initial mini-batches in the next epoch(s) contain the samples with the smallest errors and the updates are likely to be communicated. The mini-batches which include the samples associated with larger errors are less likely to be communicated to the other processing elements as they do not have enough impact on the neural network. That is, the accumulated error from the later mini-batches is minimal as compared to the initial or earlier mini-batches and communication updates are not needed. In other words, as one progresses down the sorted list, there is less to learn and therefore less to communicate to the other processing elements. This, in turn, decreases the total pressure on the communications bus. In contrast, conventional methods communicate updates independent of any learning after each mini-batch.

It should be understood that many variations are possible based on the disclosure herein. Although features and elements are described above in particular combinations, each feature or element can be used alone without the other features and elements or in various combinations with or without other features and elements.

The methods provided can be implemented in a general purpose computer, a processor, or a processor core. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors can be manufactured by configuring a manufacturing process using the results of processed hardware description language (HDL) instructions and other intermediary data including netlists (such instructions capable of being stored on a computer readable media). The results of such processing can be maskworks that are then used in a semiconductor manufacturing process to manufacture a processor which implements aspects of the embodiments.

The methods or flow charts provided herein can be implemented in a computer program, software, or firmware incorporated in a non-transitory computer-readable storage medium for execution by a general purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A method for improving communication in a neural network system, the method comprising:
in an initial epoch:
running, by each processing element in the neural network system, each sample in a training set through a neural network;
recording each error for each sample; and
sorting recorded errors in a non-decreasing order to form a sorted list;
in a next epoch:
forming mini-batches of samples based on the sorted list; and for each mini-batch of samples:
updating parameters in the neural network related to a mini-batch of samples; and
running the mini-batch of samples in the updated neural network;
coalescing errors from a number of mini-batches of samples; and
communicating updates related to the number of mini-batches of samples to other processing elements if the errors meet a significance threshold.

2. The method of claim 1, wherein the mini-batch of samples is formed starting from a sample with a smallest error in the sorted list.

3. The method of claim 2, wherein a next mini-batch of samples is formed starting from a remaining sample with the smallest error in the sorted list.

4. The method of claim 2, wherein a next mini-batch of samples is formed starting from a remaining sample with a highest error in the sorted list.

5. The method of claim 1, wherein after one or more mini-batches are run with samples based on small errors, one or more mini-batches are run with samples based on large errors.

6. The method of claim 1, wherein an error is a difference between a ground truth and a prediction from a sample, where the ground truth is the given label for the sample.

7. The method of claim 1, further comprising:
masking communication updates until a locally accumulated error meets the significance threshold.

8. The method of claim 1, wherein the significance threshold is based on a desired neural network system characteristic.

9. The method of claim 8, wherein the significance threshold is an average of a maximum error and a minimum error.

10. The method of claim 1, further comprising:
in the next epoch:
recording each error from each mini-batch of samples; and
re-sorting the sorted list.

11. A neural network system with improved communication, the system comprising:
a plurality of processing elements; and
a neural network implemented on each of the plurality of processing elements, wherein each processing element is configured to:
in an initial epoch:
running, by each processing element in the neural network system, each sample in a training set through a neural network;
recording each error for each sample; and
sorting recorded errors in a non-decreasing order to form a sorted list;
in a next epoch:
forming mini-batches of samples based on the sorted list; and
for each mini-batch of samples:
updating parameters in the neural network related to a mini-batch of samples; and
running the mini-batch of samples in updated neural network;
coalescing errors from a number of mini-batches of samples; and
communicating updates related to the number of mini-batches of samples to other processing elements if coalesced errors meet at least a significance threshold.

12. The system of claim 11, wherein the mini-batch of samples is formed starting from a sample with smallest error in the sorted list.

13. The system of claim 12, wherein a next mini-batch of samples is formed starting from a remaining sample with the smallest error in the sorted list.

14. The system of claim 12, wherein after one or more mini-batches are run with samples based on small errors, a mini-batch is run with a sample having a highest remaining error.

15. The system of claim 11, wherein after one or more mini-batches are run with samples based on small errors, one or more mini-batches are run with samples based on large errors.

16. The system of claim 11, wherein an error is a difference between a ground truth and a prediction from a sample, where the ground truth is the given label for the sample.

17. The system of claim 16, wherein each processing element is further configured to:
mask communication updates until a locally accumulated error meets the significance threshold.

18. The system of claim 11, wherein the significance threshold is based on a desired neural network system characteristic.

19. The system of claim 11, wherein the significance threshold is an average of a maximum error and minimum error.

20. The system of claim 11, wherein each processing element is further configured to:
in the next epoch:
recording each error from each mini-batch of samples; and
re-sorting the sorted list.

21. A method for improving communication in a neural network system, the method comprising:
running, by each processing element in the neural network system, mini-batches of samples through a neural network;
recording each error for each sample;
coalescing errors from a number of mini-batches of samples; and
communicating updates related to the number of mini-batches of samples to other processing elements if the errors meet a significance threshold.

22. The method of claim 21, further comprising:
sorting recorded errors in a non-decreasing order to form a sorted list;
forming the mini-batches of samples based on the sorted list;
updating parameters in the neural network related to each mini-batch of samples; and
running each mini-batch of samples in the updated neural network.

23. The method of claim 22, wherein the mini-batch of samples is formed starting from a sample with a smallest error in the sorted list.

24. The method of claim 23, wherein a next mini-batch of samples is formed starting from a remaining sample with the smallest error in the sorted list.

25. The method of claim 23, wherein after one or more mini-batches are run with samples based on small errors, a mini-batch is run with a sample having a highest remaining error.

26. The method of claim 22, wherein after one or more mini-batches are run with samples based on small errors, one or more mini-batches are run with samples based on large errors.

27. The method of claim 22, wherein an error is a difference between a ground truth and a prediction from a sample, where the ground truth is the given label for the sample.

28. The method of claim 22, further comprising:
masking communication updates until a locally accumulated error meets the significance threshold.

29. The method of claim 22, wherein the significance threshold is based on a desired neural network system characteristic.

30. The method of claim 29, wherein the significance threshold is an average of a maximum error and a minimum error.
